(19) United States
(12) Patent Application Publication
(10) Pub. No.: US 2008/0171197 A1
(43) Pub. Date: Jul. 17, 2008

(54) Automotive window, high impact interlayer

(76) Inventor: Thomas G. Rukavina, New Kensington, PA (US)

Correspondence Address: Intellectual Property Department;PPG Industries, Inc., One PPG Place, Pittsburgh, PA, 15272, US

(21) Appl. No.: 11/652,748

(22) Filed: Jan. 12, 2007

(51) Int. Cl. B32B 7/02; B29C 65/00; B32B 17/06; C08G 18/08; C08L 75/04; C08K 5/56

(52) U.S. Cl. 428/339; 156/99; 428/426; 525/453; 525/450; 524/589; 524/398

(57) ABSTRACT

The present invention discloses a method for forming a laminated window. The method includes: a) assembling a mold between two plies that make up a laminated window; b) filling the mold with a reaction mixture including: (1) at least one organic polyfunctional active hydrogen moiety having a molecular weight ranging from 500 to 2,000; (2) at least one cross-linking agent having hydroxyl functional groups or isocyanate functional groups; (3) at least one aliphatic polyisocyanate; and (4) at least one chain extender including at least one short chain diol; and c) curing the reaction mixture.

### CROSS-REFERENCE TO RELATED APPLICATIONS

This application is related to U.S. application Ser. No. ______ entitled “Automotive Window Interlayer With Solar Control Properties”, U.S. application Ser. No. ______ entitled “Method For Forming A Laminated Window That Can Exhibit A Variable Level Of Adhesion”, U.S. application Ser. No. ______ entitled “Window Interlayer With Sound Attenuation Properties”, all three applications filed concurrently herewith, and all three applications incorporated by reference in their entirety.

### FIELD OF THE INVENTION

The present invention is a novel interlayer and a laminated window that contains such an interlayer; specifcally a laminated window that exhibits improved ballistic properties.

### BACKGROUND

Laminated windows are made up of multiple plies, e.g. two plies, made of glass, plastic, or glass/plastic substrates that sandwich one or more interlayers. The windows are widely used in automotive front windshields and sidelights. Typically, laminated windows must exhibit one or more of the following properties: (1) high impact energy absorption; (2) shear and tear strength sufficient to prevent rupture of the interlayer by broken glass; (3) sufficient adhesion between the interlayer and the glass to prevent dispersion of broken glass; and/or (4) good optical qualities.

When used in a vehicle, a laminated window may need to exhibit additional properties such as, but not limited to, (a) resistance to ballistics, blast, and wind pressures, (b) sound reduction and/or (c) solar control properties depending on the application. A conventional way to change the properties of a laminated window is to modify the composition and/or configuration of the interlayer(s).

Traditional laminated windows have a polyvinyl butyral (PVB) interlayer that includes various plasticizers. Different plasticizers are added to the PVB to change the properties of the interlayer.

One of the drawbacks of a laminated window having a PVB interlayer is cost. In order to be formed into a sheet that can be used as an interlayer in a laminated window, PVB must first be extruded. Extrusion can be the process of converting plastic pellets into cut-to-size sheets of plastic using specialized equipment that subjects the pellets to both heat and pressure. Extrusion is an expensive process.

It would be desirable to have a laminated window that includes an interlayer that can be formed via a non-extrusion process, such as a cast-in-place process or a reaction injection molding (RIM) process. The present invention provides such an interlayer. The interlayer of the present invention comprises a polyurethane material that can be incorporated into a laminated window. The laminated window of the present invention exhibits good ballistic properties.

### SUMMARY OF THE INVENTION

In a non-limiting embodiment, the present invention is a method of making a polyurethane material comprising: a) reacting the following components to form a reaction mixture: (1) an organic polyfunctional active hydrogen moiety having a molecular weight ranging from 500 to 2,000; (2) a cross-linking agent having hydroxyl functional groups or isocyanate functional groups; (3) an aliphatic diisocyanate; and (4) a chain extender comprising a short chain diol, and b) curing the reaction mixture.

In another non-limiting embodiment, the present invention is a method for forming a laminated window comprising: a) assembling a mold comprising two plies that make up a laminated window, the plies being a predetermined distance apart; b) filling the mold with a reaction mixture comprising: (1) an organic polyfunctional active hydrogen moiety having a molecular weight ranging from 500 to 2,000; (2) a cross-linking agent having hydroxyl functional groups or isocyanate functional groups; (3) an aliphatic diisocyanate; and (4) a chain extender comprising a short chain diol, and c) curing the reaction mixture.

In yet another non-limiting embodiment, the present invention is a laminated window, comprising; a first and a second transparent ply; and an interlayer positioned between the first and the second plies, the interlayer being a reaction product of: (1) an organic polyfunctional active hydrogen moiety having a molecular weight ranging from 500 to 2,000; (2) a cross-linking agent having hydroxyl functional groups or isocyanate functional groups; (3) an aliphatic diisocyanate; and (4) a chain extender comprising a short chain diol.

### DETAILED DESCRIPTION OF THE INVENTION

All numbers expressing dimensions, physical characteristics, quantities of ingredients, reaction conditions, and the like used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1.0 to 7.8, 3.0 to 4.5, and 6.3 to 10.0.

As used herein, spatial or directional terms, such as “left”, “right”, “inner”, “outer”, “above”, “below”, “top”, “bottom”, and the like, are understood to encompass various alternative orientations and, accordingly, such terms are not to be considered as limiting.

The present invention is a method of making a novel polyurethane material that can be formed into an interlayer for a laminated window. The polyurethane material can be a polycarbonate based. polyurethane, a polyester based polyurethane, a polyether based polyurethane or blends thereof.

According to the present invention, the first step in making the polyurethane material involves reacting the following components to form a reaction mixture:

(1) at least one organic polyfunctional active hydrogen moiety having a molecular weight ranging from 500 to 2,000;

(2) at least one cross-linking agent having hydroxyl functional groups or isocyanate functional groups;

(3) at least one aliphatic polyisocyanate; and

(4) at least one chain extender comprising at least one short chain diol.

According to the present invention, suitable organic polyfunctional active hydrogen moieties having a molecular weight ranging from 500 to 2,000 include, but are not limited to, polytetramethyleneoxide polyol, polycarbonate polyols, polyester polyols, organofunctional silicones, and mixtures thereof.

According to the present invention, suitable cross-linking agents include, but are not limited to, trimethylol propane (TMP), pentaerythritol, glycerol, and mixtures thereof.

According to the present invention, suitable aliphatic polyisocyanates include diisocyanates and triisocyanates. Examples of suitable aliphatic diisocyanates include, but are not limited to, monomeric diisocyanates such as bis(4-isocyanato-cyclohexyl)methane, which is commercially available from Bayer Corporation (Pittsburgh, Pa.) as DESMODUR® W; hexamethylene diisocyanate; 4,4-bis(cyclohexyl)methane diisocyanate; isophorone diisocyanate; 1-methylcyclohexane-2,4-diisocyanate; trimethyl hexamethylene diisocyanate (TMDI), and mixtures thereof. A suitable aliphatic triisocyanate includes, but is not limited to, 4,4′,4″-tricyclohexylmethane triisocyanates.

According to the present invention, suitable chain extenders include, but are not limited to, short chain diols. As used herein, the term “short chain” means the diol has no more than 12 carbon atoms, for example, between 2 and 12 carbon atoms. Non-limiting examples of suitable short chain diols are 1,4 butanediol and blends of cyclohexanedimethanol and butanediol.

In a non-limiting embodiment of the present invention, the materials described above are reacted in the equivalent ranges shown in Table 1 below.

TABLE 1
Equivalent ranges of reacted materials

| Component | Equivalent range |
|---|---|
| (1) organic polyfunctional active | up to 0.5 |
| hydrogen moiety having a molecular | |
| weight ranging from 500 to 2,000 | |
| (2) cross-linking agent having | 0.7 |
| hydroxyl functional groups or | |
| isocyanate functional groups | |
| (3) aliphatic polyisocyanate | 1.0 |
| (4) chain extender | up to 1.0 |

The reaction conditions are typical of the conditions used to synthesize polyurethane materials and are well known in the art.

In a non-limiting embodiment of the invention, dyes can be added to the reaction mixture for making the polyurethane to influence the color of the interlayer. The dyes simply dissolve in the reaction mixture. Suitable dyes include, but are not limited to, nanopigments, ultraviolet (UV) light stable organo tungsten dyes, etc., and mixtures thereof. Depending on the dye(s) used, the interlayer can exhibit one of the following colors: blue, green, red, yellow, pink, etc.

In another non-limiting embodiment of the invention, the dyes are not added to the reaction mixture for making the polyurethane. They are added at a later time, for example, after the reaction mixture is cured as described below. The dyes simply dissolve into the cured material.

In a non-limiting embodiment, the dye is an organo tungsten dye prepared by reacting tungsten hexachloride with an alkyl ester of phosphoric acid. In order to prepare the dye, one mole of tungsten hexachloride is reacted with 3 or more moles of an alkyl ester of phosphoric acid. The organo tungsten dye provides a grayish-blue color to an interlayer.

In a non-limiting embodiment, the reaction mixture can include from 2% to 25% by weight of the reaction mixture of a material that contains functional groups capable of being cured by exposure to UV light such as, but not limited to, urethane acrylate, hyroxyethyl acrylates, hydroxypropyl acrylates, acrylamide, and mixtures thereof. Such compounds will be very beneficial in the curing step described below; especially if UV curing is utilized.

In various non-limiting embodiments of the invention, one or more catalysts can be added to the reaction mixture. Suitable catalysts include UV catalysts, for example, diphenyl(2,4,6 trimethyl)benzoyl phosphine oxide, and thermal catalysts such as dibutyltin dilaurate and butyl stannoic acid.

According to the present invention, the second step in making the polyurethane material involves curing the reaction mixture. The composition can be cured by thermal curing, curing using UV light, or a combination of thermal and UV curing.

In a non-limiting embodiment, the composition is cured by a combination of thermal and UV curing. In this embodiment, the mixture is UV cured first. For example, the reaction mixture can be exposed to an UV light source for a period ranging from 30 seconds to 2 minutes. After the mixture has been exposed to UV light, it is thermally cured. For example, the mixture is thermally cured by placing it in an oven and heating it at a temperature ranging from 180° F. to 290° F. (82° C. to 143° C.) for a period ranging from 15 minutes and 2 hours.

As used herein, UV light cure refers to exposing the material to wavelengths between 220-450 nm of the electromagnetic spectrum. Suitable sources of ultraviolet radiation include natural sources, like solar radiation, and artificial sources like black light or an ultraviolet light source.

In another non-limiting embodiment of the invention, the mixture is thermally cured. For example, the mixture is thermally cured by placing it in an oven and heating it at a temperature ranging from 180° F. to 290° F. (82° C. to 143° C.) for a period ranging from 15 minutes and 2 hours.

The present invention also encompasses a method for forming a laminated window having an interlayer comprising the polyurethane material described above sandwiched between two transparent plies. Typically, the plies are glass or plastic or one of each, as is well known in the art.

According to the present invention, the polyurethane interlayer is made at the same time the laminated window is being made. In this embodiment, the polyurethane interlayer is made via a casting or reaction injection molding (RIM) process as is well known in the art. The first step in the method of forming the laminated window of the invention comprises assembling a mold (also referred to as a “cast” in the art) between the two plies that will make up the laminated window. The cast can be made of any materials and in any way known in the art. In a non-limiting embodiment of the invention, the cast comprises two plies that are spaced apart at a predetermined distance equal to the desired thickness of the interlayer.

According to the present invention, a next step in the method for forming the laminated window involves filling the cast with the reaction mixture for making the polyurethane material as described above. In a non-limiting embodiment, the filling step comprises pouring or pumping at least partially uncured polyurethane material into the cast.

According to the present invention, a next step in the method for forming the laminated window involves curing the reaction mixture. The curing step is accomplished in the manner described above.

In a non-limiting embodiment, the interlayer of the invention is in the form of a sheet having a thickness ranging from 30 mils to 1 inch (0.076 cm to 2.54 cm). Thinner and thicker sheets can be used depending upon the application.

The present invention also encompasses a laminated window formed from the method described above. The laminated window of the present invention can be used in various automotive, architectural and aerospace applications. For example, the laminated window can be used as an automotive windshield, an automotive sidelight, an aircraft window, storefront display windows, sky lights, etc.

When the laminated window of the present invention is used in an automotive and airplane window, it may need to meet certain performance requirements.

In a non-limiting embodiment, a laminated window incorporating the interlayer of the present invention exhibits a visible light transmittance ranging from 70% to 90% and no greater than 0.5% haze as measured by a haze-gloss meter sold by BYK-Gardner USA (Columbia, Md.). The interlayer should also exhibit consistent mechanical properties up to a temperature of 180° F. (82° C.).

In certain instances, a laminated window must exhibit a certain level of adhesion, for example, when the laminated window is used as an automotive windshield in the United States. In a non-limiting embodiment, the degree of adhesion exhibited by the laminated window ranges from 1 to 10 pounds per lineal inch (1.75×10² N/m to 1.75×10³ N/m) as determined by a 90° Peel Test according to NASA TECH BRIEF 65-10173. This level of adhesion is low enough to allow sufficient interlayer to release from the glass so that it can stretch without tearing to absorb impacting energy. Further, this level of adhesion is high enough to sufficiently retain any broken glass. Higher degrees of adhesion, that is, much higher than 10 pounds per lineal inch (1.75×10³ N/m), results in decreases in impact resistance and higher severity indices, as will be described later.

When a laminated window is subject to adhesion requirements, not only must it exhibit an initial degree of adhesion within a prescribed range, the degree of adhesion should also be relatively stable under a wide range of temperature and humidity conditions. By relatively stable under a wide range of temperature and humidity conditions, it is meant that although there may be fluctuations in the adhesive value over a period of time, the degree of adhesion as determined by NASA TECH BRIEF 65-10173 remains within 1 pound to 10 pounds per lineal inch (1.75×10² N/m to 1.75×10³ N/m) after exposure to temperatures ranging from −50° F. to 120° F. (−46° C. to 49° C.) and relative humidities ranging from 0 to 100 percent for at least 5 days.

In order to produce a laminated window that exhibits the required level of adhesion, various adhesion promoters. and/or adhesion inhibitors can be included in the reaction mixture. In this way, a desirable level of adhesion is provided initially and that level of adhesion is maintained under various conditions, such as extremely high humidity conditions. According to the present invention, suitable adhesion promoters include, but are not limited to, alkoxy silanes, such as glycidyl-oxypropyltrimethoxy silane sold by the Dow Corning Company (Midland, Mich.) under the trademark Z-6040®, and gamma-glycidoxy propyltrimethoxy silane. In a non-limiting embodiment, the adhesion promoter is present in a concentration ranging from 0.05 to 0.12 percent by weight of the reaction mixture.

In a non-limiting embodiment of the present invention, where the adhesive properties of reaction mixture are too high, adhesive inhibitors can be used.

According to the present invention, a suitable adhesion inhibitor is stearyl acid phosphate. In a non-limiting embodiment, the adhesion inhibitor is present in a concentration ranging from 0.05 to 0.12 percent by weight of the reaction mixture.

The laminated window of the present invention may exhibit good ballistic properties. In a non-limiting embodiment of the invention, the laminated window of the present invention can withstand a 90 pound (40.82 kg) dumbbell drop from a height of 4 feet (1.22 m).

### EXAMPLES

The present invention is illustrated by the following non-limiting examples:

### Example 1

The interlayer of Example 1 was prepared by reacting the components listed in Table 2 in a 3 liter glass kettle to form an isocyanate terminated urethane prepolymer with excess free diisocyanate. The components were added to the kettle in the amounts shown.

In the examples, the following materials were used as organic polyfunctional active hydrogen moieties having a molecular weight ranging from 500 to 2,000: PLURACOL® E400NF, PLURONIC® L62D and CAPA® 2077A. Trimethylopropane was used as the cross-linking agent having hydroxyl functional groups or isocyanate functional groups. DESMODUR® W was used as the aliphatic diisocyanate. Butanediol and 1,4 cyclohexanedimethanol were used as the chain extenders.

TABLE 2
Prepolymer Components in the Reaction Mixtures used
to make Ex. 1

| Ingredients | Wt. % |
|---|---|
| DESMODUR ® W¹ | 54.4178 |
| DBT FASTCAT 4202² | 0.0049 |
| PLURACOL ® E400NF³ | 5.0948 |
| PLURONIC ® L62D⁴ | 33.9656 |
| TRIMETHYLOPROPANE | 2.3232 |
| CAPA ® 2077A⁵ | 1.2341 |
| IRGANOX ® 1010⁶ | 0.4852 |
| CYASORB ® UV 5411⁷ | 0.9704 |
| TINUVIN ® 328⁸ | 1.4555 |
| IRGANOX ® MD 1024⁹ | 0.0485 |
| | 100.0000 |

¹Desmodur ® W is a cycloaliphatic diisocyanate commercially available from Bayer Corporation (Pittsburgh, PA).
²DBT Fastcat 4202 (dibutyltin dilaurate) is a catalyst commercially available from Elf-Altochem North America, Inc. (Philadelphia, PA).
³Pluracol ® E400NF is a polyol commercially available from BASF (Germany).
⁴Pluronic ® L62D is a surfactant used in a variety of applications ranging commercially available from BASF Corporation (Florham Park, NJ).
⁵CAPA ® 2077A is a premium grade polycaprolactone polyester diol having a molecular weight of 750 and a typical OH value of 150 mg KOH/g commercially available from Solvay Caprolactones (United Kingdom).
⁶Irganox ® 1010 is a high molecular weight, phenolic antioxidant with low volatility commercially available from Ciba Specialty Chemicals (New York, NY).
⁷Cyasorb ® UV 5411 is a UV absorber commercially available from Cytec Corporation (New Jersey).
⁸Tinuvin ® 328 is a hydroxyphenylbenzotriazole that is used as a UV absorber for ambient and low temperature cured systems commercially available from Ciba Specialty Chemicals (New York, NY).
⁹Irganox ® MD 1024 is a primary phenolic antioxidant commercially available from Ciba Specialty Chemicals (New York, NY).

6.9 grams of butanediol, and 18.6 grams of 1,4 cyclohexanedimethanol were added to the kettle. The kettle was heated to 250° F. (121° C.) for 30 minutes and the contents of the kettle were poured into a glass mold.

The reaction mixture was then injected between two clear, glass plies, each having a thickness of 2 mm, at a pressure of 1000 centipoise. The reaction mixture was then thermally cured for 2 hours at 275° F. (135° C.) to make a laminated window. The space between the two plies and, thus, the thickness of the resulting interlayer in the laminated window, was 50 mils.

The laminated window was then subjected to a 90 pound (40.82 kg) dumbbell test. During the dumbbell test, the laminate was secured in a frame, and a 90 pound (40.82 kg) weight was dropped from 4 feet (1.22 m) in height onto the laminate.

The glass broke, but the interlayer kept the weight from penetrating and going through the laminate. The interlayer passed the test. If the dumbbell had gone through the laminate, the interlayer would not have passed this test.

### Example 2

The 90 pound (40.82 kg) dumbbell test was administered to Example 2. Example 2 was made in the same manner as Example 1 except 12.5 grams of 1,4 butanediol was added to the components shown in Table 1. The reaction mixture was then cast and cured in the manner described above.

During the 90 pound (40.82 kg) dumbbell test, the laminated window of Example 2 deflected several times, and the weight bounced off of the window without any glass breakage.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

We claim:

1. A method of making a polyurethane material comprising:
a) reacting the following components to form a reaction mixture;
(1) at least one organic polyfunctional active hydrogen moiety having a molecular weight ranging from 500 to 2,000;
(2) at least one cross-linking agent having hydroxyl functional groups or isocyanate functional groups;
(3) at least one aliphatic polyisocyanate; and
(4) at least one chain extender comprising at least one short chain diol, and
b) curing the reaction mixture.

2. The method according to claim 1, wherein the at least one organic polyfunctional active hydrogen moiety is selected from polytetramethyleneoxide polyol, polycarbonate polyols, polyester polyols, organofunctional silicones, and mixtures thereof.

3. The method according to claim 1, wherein the at least one cross-linking agent is selected from trimethylol propane (TMP), pentaerythritol, glycerol, and mixtures thereof.

4. The method according to claim 1, wherein the aliphatic polyisocyanate is selected from an aliphatic diisocyanate and an aliphatic triisocyanate.

5. The method according to claim 4, wherein the aliphatic diisocyanate is selected from bis(4-isocyanato-cyclohexyl)methane; hexamethylene diisocyanate; 4,4-bis(cyclohexyl)methane diisocyanate; isophorone diisocyanate; 1-methylcyclohexane-2,4-diisocyanate; trimethyl hexamethylene diisocyanate (TMDI); and mixtures thereof.

6. The method according to claim 4, wherein the aliphatic triisocyanate is 4,4′,4″-tricyclohexylmethane triisocyanate.

7. The method according to claim 1, wherein the chain extender comprises a diol having no more than 12 carbon atoms.

8. The method according to claim 1, wherein the components are reacted in the following equivalent ranges:
(1) organic polyfunctional active hydrogen moiety having a molecular weight ranging from 500 to 2,000 at an equivalent range up to 0.5;
(2) cross-linking agent having hydroxyl functional groups or isocyanate functional groups at an equivalent range of 0.7;
(3) aliphatic polyisocyanate at an equivalent range of 1.0; and
(4) chain extender at an equivalent range up to 1.0.

9. The method according to claim 1, wherein the reaction mixture further comprises a dye selected from nanopigments, organo tungsten dyes, and mixtures thereof.

10. The method according to claim 5, wherein the dye is an organo tungsten dye prepared by reacting one mole of tungsten hexachloride with 3 or more moles of an alkyl ester of phosphoric acid.

11. The method according to claim 1, wherein the reaction mixture further comprises 2% to 25% by weight of the reaction mixture of a material that contains functional groups capable of being cured by exposure to ultraviolet light selected from urethane acrylates, hyroxyethyl acrylates, hydroxypropyl acrylates, acrylamide, and mixtures thereof.

12. The method according to claim 1, wherein the reaction mixture comprises an ultraviolet light catalyst or a thermal catalyst or both.

13. The method according to claim 1, wherein the curing step comprises thermal curing, ultraviolet light curing, or both.

14. An interlayer formed by the method of claim 1.

15. A method for forming a laminated window comprising:
a) assembling a mold comprising two plies that make up a laminated window, the plies being a predetermined distance apart;
b) filling the mold with a reaction mixture comprising:
(1) at least one organic polyfunctional active hydrogen moiety having a molecular weight ranging from 500 to 2,000;
(2) at least one cross-linking agent having hydroxyl functional groups or isocyanate functional groups;
(3) at least one aliphatic polyisocyanate; and
(4) at least one chain extender comprising a short chain diol, and
c) curing the reaction mixture.

16. The method according to claim 15, wherein the curing comprises thermal curing, ultraviolet light curing, or both.

17. A laminated window, comprising:
a first and a second transparent ply; and
an interlayer positioned between the first and the second plies which is a reaction product of:
(1) at least one organic polyfunctional active hydrogen moiety having a molecular weight ranging from 500 to 2,000;
(2) at least one cross-linking agent having hydroxyl functional groups or isocyanate functional groups;
(3) at least one aliphatic polyisocyanate; and
(4) at least one chain extender comprising a short chain diol.

18. The laminated window according to claim 17, wherein the interlayer is in the form of a sheet having a thickness ranging from 30 mils to 1 inch.

19. The laminated window according to claim 17, wherein the laminated window exhibits a degree of adhesion ranging from 1 to 10 pounds per lineal inch (1.75×10² N/m to 1.75×10³ N/m) as determined by a 90° Peel Test according to NASA TECH BRIEF 65-10173.
